(19) United States
(12) Patent Application Publication
(10) Pub. No.: US 2010/0287599 A1
(43) Pub. Date: Nov. 11, 2010

(54) METHOD, APPARATUS AND SYSTEM FOR IMPLEMENTING POLICY CONTROL

(75) Inventors: Xianhui HE, Shenzhen (CN); Saixiang Fu, Shenzhen (CN)

Correspondence Address: STAAS & HALSEY LLP, SUITE 700, 1201 NEW YORK AVENUE, N.W., WASHINGTON, DC, 20005, US

(73) Assignee: HUAWEI TECHNOLOGIES CO., LTD., Shenzhen (CN)

(21) Appl. No.: 12/830,698

(22) Filed: Jul. 6, 2010

Related U.S. Application Data
(63) Continuation of application No. PCT/CN2009/070026, filed on Jan. 5, 2009.

(30) Foreign Application Priority Data
Jan. 7, 2008 (CN) 200810000212.4

(51) Int. Cl. H04L 29/06

(52) U.S. Cl. 726/1

(57) ABSTRACT

A method, an apparatus and a system for implementing policy control are disclosed. The method includes: an SPDF receives a service request that carries service property of a session from an AF, makes a service policy decision according to the service property of the session and policy pre-configuration parameters to obtain authorized service parameters; and determines a corresponding local network transmission PDF according to a type of an access network; the SPDF sends an access network resource authorization request that carries the authorized service parameters to the determined local network transmission PDF, to enable the local network transmission PDF to generate a local network transmission policy according to the authorized service parameters and deliver the policy to a corresponding policy enforcement point for enforcing. Through the embodiments of the present invention, the converged policy control can be implemented for different types of networks.

### CROSS-REFERENCE TO RELATED APPLICATIONS

This application is a continuation of International Application No. PCT/CN2009/070026, filed on Jan. 5, 2009, which claims priority to Chinese Patent Application No. 200810000212.4, filed on Jan. 7, 2008, both of which are hereby incorporated by reference in their entireties.

### FIELD OF THE INVENTION

The present invention relates to communication technologies, and in particular, to a method, a system, and an apparatus for implementing policy control.

### BACKGROUND

FIG. 1 shows a Worldwide Interoperability for Microwave Access (WiMAX) network architecture in the prior art. A WiMAX network includes three parts: Mobile Station (MS), Access Service Network (ASN), and Connectivity Service Network (CSN), The ASN includes: Base Station (BS), Access Service Network Gateway (ASN-GW), and so on. A CSN includes logical entities such as Prepaid Server (PPS) and Authentication Authorization Accounting (AAA) server. The MS is connected with the ASN through an R1 interface; the MS is connected with the CSN through an R2 interface; the ASN is connected with the CSN through an R3 interface; the ASNs are interconnected through an R4 interface; the CSNs are interconnected through an R5 interface; and the BS in the ASN is connected with the ASN-GW through an R6 interface. In the WiMAX network, the wireless side employs a Wireless Metropolitan Area Network (WMAN) access technology based on Institute of Electrical and Electronics Engineers (IEEE) 802.16.

Meanwhile, the 3rd Generation Partnership Project (3GPP) and 3GPP2 define a Policy Control and Charging (PCC) framework. The PCC framework is applicable to connecting to the access network through Internet Protocol (IP), and is designed to perform resource admission control and implement Quality of Service (QoS) control and charging policy control in light of the features of the mobile access network. The PCC framework is capable of implementing policy control based on user customization information and implementing charging control based on service flows. The PCC is located between the service control layer and the access layer or bearer layer, and shields detailed technical and topological information of the access layer or bearer layer against the service control layer. Specifically, the PCC receives QoS authorization parameters from the service control layer, combines the parameters with the admission control policy and network topology information, converts the QoS parameters of the service into IP QoS parameters, and then submits the parameters to the relevant access-layer or bearer-layer nodes and the service gateway node. Such nodes implement the QoS control according to the received information and their own functions. The policy control refers to gating control and QoS control, and charging control refers to Flow-Based Charging (FBC).

FIG. 2 shows a basic PCC architecture based on 3GPP or 3GPP2 in the prior art, which includes the following entities:

Application Function (AF): configured to provide applications, where the applications need to perform dynamic policy control and charging control for the user plane of the IP access network;

Subscription Profile Repository (SPR): configured to store user subscription profile;

Policy Control and Charging Rule Function (PCRF): The PCRF is configured to make decision of control policy and make flow-based decision of charging policy. The control policy decision means that the PCRF determines the QoS authorization information according to the service information from the AF and the subscription profile in the SPR. The QoS authorization information may be QoS level and bit rate. The flow-based decision of charging policy means that the PCRF uses subscription profile as a benchmark of policy control decision and charging control decision, determines the PCC rules and submits them to a Policy and Charging Enforcement Function (PCEF); and

PCEF: configured to enforce QoS policy, detect the service data flows, and perform flow-based charging and access control.

The PCC architecture is not only provided in 3GPP/3GPP2, but also provided in WiMAX in order to accomplish dynamic policy control and authorization of the service. As shown in FIG. 3, in this architecture, in order to support migration of access network PCEF (A-PCEF) in the WiMAX access network, a Policy Decision Function (PDF) is introduced in the WiMAX PCC architecture to shield mobility of the PCC policy enforcement point (PCEF) in the WiMAX network against the PCRF. Besides, because A-PCEF and optional core network PCEF (C-PCEF) exist in the WiMAX network, the PCC rules may be distributed to the A-PCEF and the C-PCEF through the PDF.

In the prior art, not only a PCC architecture is provided for mobile networks, but also a Resource and Admission Control Subsystem (RACS) is provided for fixed networks. The RACS provides a universal policy-based bearer control mechanism for applications so that Value Added Services (VASs) can obtain corresponding network resources. The RACS isolates the application layer from the transport layer, thus shielding details of the transport layer against the application layer. The main functions of the RACS include admission control, resource reservation, policy control, and Network Address Translation (NAT)/access control. Specifically, the RACS divides the bearer control function includes into two parts expressly: Service-based Policy Decision Function (SPDF), and Access network-Resource and Admission Control Function (A-RACF).

The SPDF is configured to: decide service QoS parameters according to a service property and policy pre-configuration parameters of the session; interact with a Core network Border Gateway Function (C-BGF) to perform NAT/NAT-PT; indicate media stream transmission policy to the C-BGF; and request the A-RACF to perform resource admission control. The SPDF is independent of access. Through indirect control exercised by the A-RACF, the SPDF provides control capabilities which cover the whole access network and the core network edge (C-BGF).

The A-RACF is configured to: receive a CAC request from the SPDF, and judge the legality of the session resource according to the QoS subscription profile of the user; perform admission control according to the QoS parameters of the session and the resource topology of the access network; and generate a transmission policy according to the QoS parameters of the session, features of the access network, and features of the bearer point, and install the policy onto the bearer gateway.

It is thus evident that in the prior art, a system for implementing policy control is provided for the mobile network and a system for implementing policy control is provided for the fixed connection network respectively. Such systems have their own interfaces to the application layers, and perform policy control for the corresponding networks respectively. When the network is evolving and converging, an architecture for performing policy control uniformly for both the fixed connection network and the mobile network is required. However, no solution is available to integrated policy control for different networks in the prior art.

### SUMMARY

The embodiments of the present invention provide a method, an apparatus, and a system for implementing policy control to perform integrated policy control for different networks.

The embodiments of the present invention provide the following technical solutions:

A method for implementing policy control includes:

by an SPDF, receiving a service request that carries a service property of a session from an AF, making a service policy decision according to the service property of the session and policy pre-configuration parameters to obtain authorized service parameters; and determining a corresponding local network transmission PDF according to a type of an access network; and

sending, by the SPDF, an access network resource authorization request that carries the authorized service parameters to the determined local network transmission PDF, to enable the local network transmission PDF to generate a local network transmission policy according to the authorized service parameters and deliver the policy to a corresponding policy enforcement point for enforcing.

An SPDF for implementing policy control includes:

a service policy deciding unit, configured to: make a service policy decision according to policy pre-configuration parameters and a service property of a session to obtain authorized service parameters, wherein the service property of the session are carried in a service request sent by an AF;

a local network transmission PDF determining unit, configured to determine a corresponding local network transmission PDF according to a type of an access network; and

an access network resource authorization request unit, configured to send an access network resource authorization request to the determined local network transmission PDF, where the request carries the authorized service parameters.

A local network transmission PDF for implementing policy control includes:

an authorized service parameter receiving unit, configured to receive authorized service parameters sent by an SPDF; and

a local network policy generating unit, configured to: generate a local network transmission policy according to the authorized service parameters, and deliver the policy to a corresponding policy enforcement point for enforcing.

A system for implementing policy control includes:

an SPDF, configured to: make a service policy decision according to service policy pre-configuration parameters and a service property of a session to obtain authorized service parameters, wherein the service property of the session are carried in a service request sent by an AF; determine a corresponding local network transmission PDF according to a type of an access network; and send an access network resource authorization request that carries the authorized service parameters to the determined local network transmission PDF; and

the local network transmission PDF, configured to: generate a local network transmission policy according to the authorized service parameters after receiving the access network resource authorization request from the SPDF, and deliver the policy to a corresponding policy enforcement point for enforcing.

In the embodiments of the present invention, the SPDF determines the corresponding local network transmission PDF according to the type of the access network, and the local network transmission PDF implements admission control and generates transmission policy. Therefore, integrated policy control can be implemented between different networks, especially between a fixed connection network and a mobile network, and unified resource authorization and control can be implemented for different bearer access networks.

### BRIEF DESCRIPTION OF THE DRAWINGS

FIG. 1 shows a WiMAX network architecture in the prior art;

FIG. 2 shows a basic PCC architecture based on 3GPP or 3GPP2 in the prior art;

FIG. 3 shows a basic PCC architecture of WiMAX in the prior art;

FIG. 4 shows a system for implementing policy control in an embodiment of the present invention;

FIG. 5 is a flowchart of a method for implementing policy control in an embodiment of the present invention;

FIG. 6 is a signaling flowchart of a resource request process in an embodiment of the present invention;

FIG. 7 is a signaling flowchart of a resource modification process in an embodiment of the present invention;

FIG. 8 is a signaling flowchart of a resource release process in an embodiment of the present invention;

FIG. 9 is a modular diagram of an SPDF for implementing policy control in an embodiment of the present invention; and

FIG. 10 is a modular diagram of a local network transmission PDF for implementing policy control in an embodiment of the present invention.

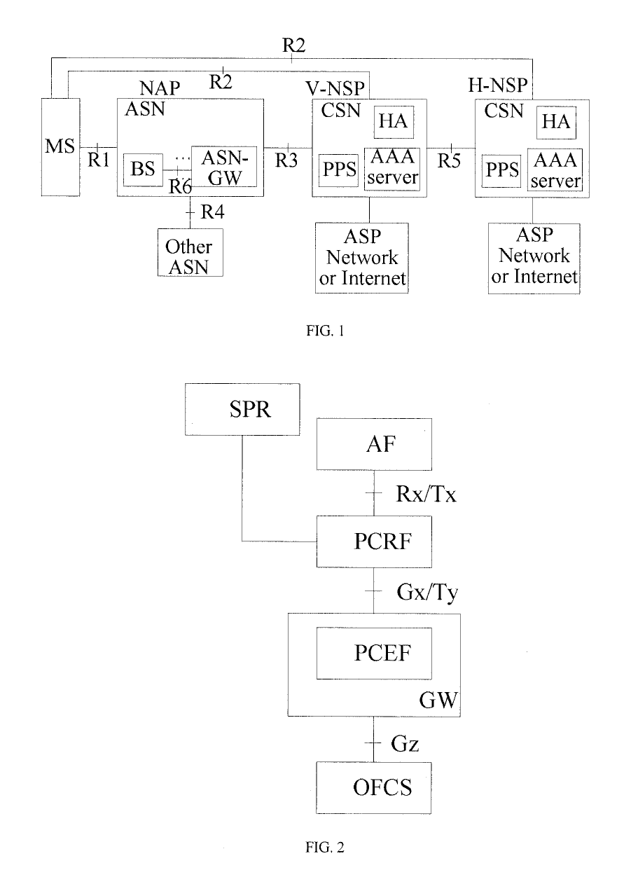

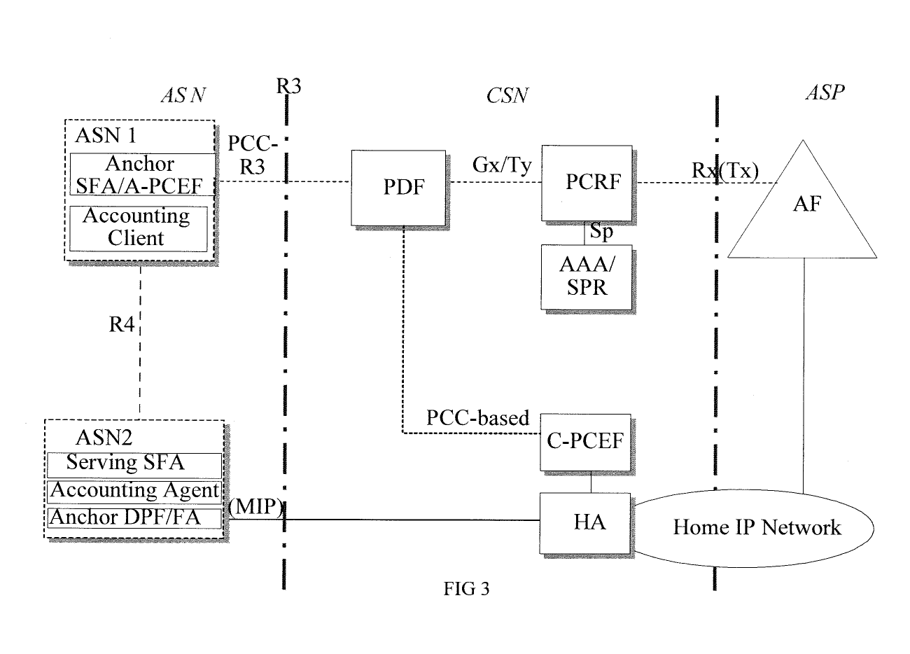

### DETAILED DESCRIPTION OF THE EMBODIMENTS

The embodiments of the present invention are elaborated below with reference to accompanying drawings.

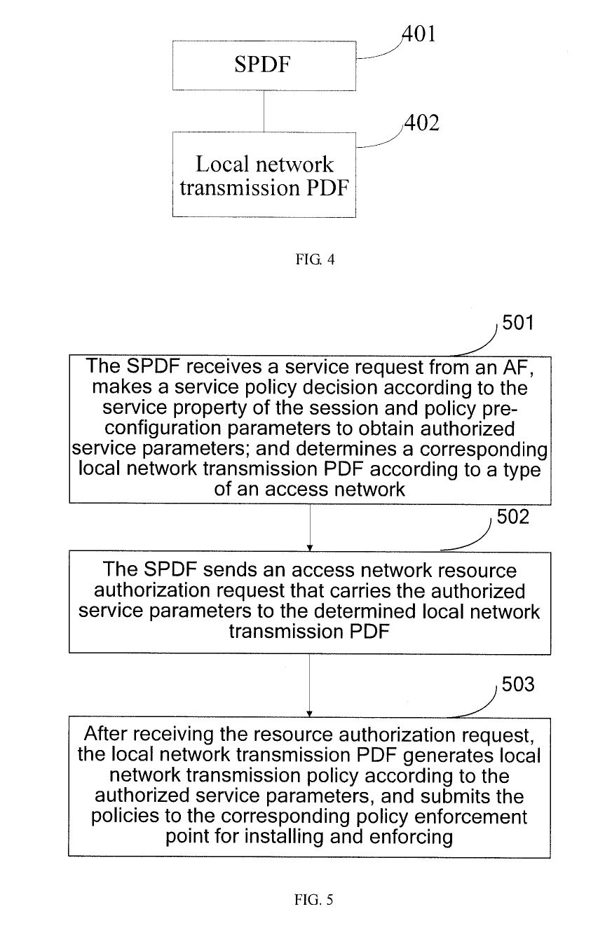

As shown in FIG. 4, a system provided in an embodiment of the present invention includes an SPDF 401 and a local network transmission PDF 402.

The SPDF 401 provides interfaces to the application layer, and is configured to: make service policy decision according to service policy pre-configuration parameters and a service property of a session to obtain authorized service parameters, where the service property of the session are carried in a service request sent by an AF; determine a corresponding local network transmission PDF according to a type of an access network; and send an access network resource authorization request that carries the authorized service parameters to the determined local network transmission PDF.

The local network transmission PDF 402 is configured to: generate a local network transmission policy according to the authorized service parameters after receiving the access network resource authorization request from the SPDF 401, and deliver the policy to a corresponding policy enforcement point for installing and enforcing. More specifically, the local network transmission PDF 402 may generate the local network transmission policy in the following way:

After receiving the access network resource authorization request sent by the SPDF 401, the local network transmission PDF 402 performs access network resource policy authorization according to authorized service parameters and access network policy to obtain authorized service parameters that are obtained after the access network resource authorization; generates a local network transmission policy according to the obtained authorized service parameters, and delivers the policy to the corresponding policy enforcement point for installing and enforcing. In a preferred embodiment of the present invention, the local network transmission policy may be generated further according to features of the access network and/or features of the policy enforcement point.

It is worthy of attention that: In a preferred embodiment of the present invention, the SPDF provides a uniform interface to the application layer so that different types of networks can be better converged through the uniform interface.

In the case that the local network is a mobile network, local network transmission PDF may be a PCRF. Specifically, the PCRF can perform mobile network resource policy authorization according to the authorized session QoS parameters and access network policy of the mobile network. Moreover, according to the mobile network features of the local access network and the features of the policy enforcement point (for example, ASN PCEF, or C-PCEF), the PCRF generates PCC rules, and deliver the PCC rules to the policy enforcement point for installing and enforcing. Therefore, the PCEF can perform transmission control according to the PCC rules.

In the case that the local network is a fixed connection network, the local network transmission PDF may be an access network RACF (A-RACF). The A-RACF performs resource policy authorization for the fixed connection network according to the authorized session QoS parameters and the access network policy of the fixed connection network. Moreover, according to the features of the local access network (such as LAN and xDSL) and the features of the bearer point (such as DSLAM and BRAS) in the fixed connection network, the A-RACF generates transmission policy of the fixed connection network, and installs the transmission policy onto a bearer gateway such as Resource Control Enforcement Function (RCEF) so that the RCEF can perform transmission control according to the transmission policy of the fixed connection network.

Further, in order to support migration of A-PCEF in the mobile network, the system may further include a policy distribution function. The policy distribution function is configured to shield the mobility of the PCC policy enforcement point (PCEF) against the PCRF in the mobile network, and may be further configured to distribute PCC rules to the A-PCEF and the C-PCEF.

In a preferred embodiment of the present invention, the SPDF may be further configured to:

interact with the C-BGF to perform NAT/NAT-PT, and/or indicate media stream transmission policy to the C-BGF.

The local network transmission PDF may be further configured to:

judge whether session resources are legal according to user subscription profile after receiving the access network resource authorization request from the SPDF; continue to perform the access network resource policy authorization and generate the local network transmission policy if the session resources are legal, or refuse to provide the access network resources for the user if the session resources are not legal.

In a preferred embodiment of the present invention, in order to integrate the mobile network with the fixed connection network with respect to charging, the Gq′ interface between the AF and the SPDF and the Rq interface between the SPDF and the local network transmission PDF are extended. In this way, through such interfaces, the charging identifier of the application layer and the access network as well as the charging point address can be transmitted, and the application layer charging is correlated with the access network charging. More specifically, the Gq′ interface is extended, and therefore, through the extended interface, the AF can add the application layer charging ID (AF-Charging-ID) into service property of the service request directed to the SPDF; the Rq interface is extended, and therefore, through the extended interface, the PCRF in the mobile network can add the access network charging ID and the charging point address into a resource authorization response directed to the SPDF. For such interface extending, the SPDF in the system is further configured to:

obtain an application layer charging ID from the service property of the service request sent by the AF, and add the ID into the access network resource authorization request directed to the local network transmission PDF; and

return the access network charging ID and the charging point address sent by the local network transmission PDF to the AF so that the AF can correlate the access network charging with the application layer charging.

The local network transmission PDF is further configured to:

return the access network charging ID and the charging point address to the SPDF through the extended Rq interface.

As in the above embodiment, through the extended Rq interface, the application layer charging ID, the access network charging ID, and the charging point address can be transmitted, the application layer charging is correlated with the access network charging, and different types of networks are integrated with respect to charging policy control.

In light of the system shown in FIG. 4, a method for implementing policy control is provided in an embodiment of the present invention. As shown in FIG. 5, the method includes the following steps:

Step 501: The SPDF receives a service request that carries service property of a session from an AF, makes a service policy decision according to the service property of the session and policy pre-configuration parameters to obtain authorized service parameters; and determines a corresponding local network transmission PDF according to a type of an access network.

In a preferred embodiment of the present invention, the SPDF in this step can receive the service request through the uniform interface to the application layer, and therefore, different types of networks can be better integrated with respect to policy control. The parameters such as service property and access network type can be carried in the service request, and the SPDF can obtain such parameters from the service request.

Step 502: The SPDF sends an access network resource authorization request that carries the authorized service parameters to the determined local network transmission PDF.

Step 503: After receiving the resource authorization request, the local network transmission PDF generates local network transmission policy according to the authorized service parameters, and submits the policy to the corresponding policy enforcement point for installing and enforcing. Details of step 503 may be:

The local network transmission PDF generates the local network transmission policy in the following way:

After receiving the access network resource authorization request sent by the SPDF 401, the local network transmission PDF performs access network resource policy authorization according to authorized service parameters and access network policy to obtain authorized service parameters that are obtained after the access network resource authorization; generate local network transmission policy according to the obtained authorized service parameters, and deliver the policy to the corresponding policy enforcement point for installing and enforcing. In a preferred embodiment of the present invention, the local network transmission policy may be generated according to features of the access network and/or features of the policy enforcement point.

Further, in order to correlate the access network charging with the application layer charging, in step 501, the SPDF receives the application layer charging ID sent by the AF, and sends the ID to the local network transmission PDF.

Accordingly, in step 503, the local network transmission PDF further sends the access network charging ID and the charging point address to the AF through the SPDF, and therefore, the AF can correlate the application layer charging with the access network charging according to the ID and the address.

Taking a resource request process and a resource modification process as examples, the following gives details of the foregoing method:

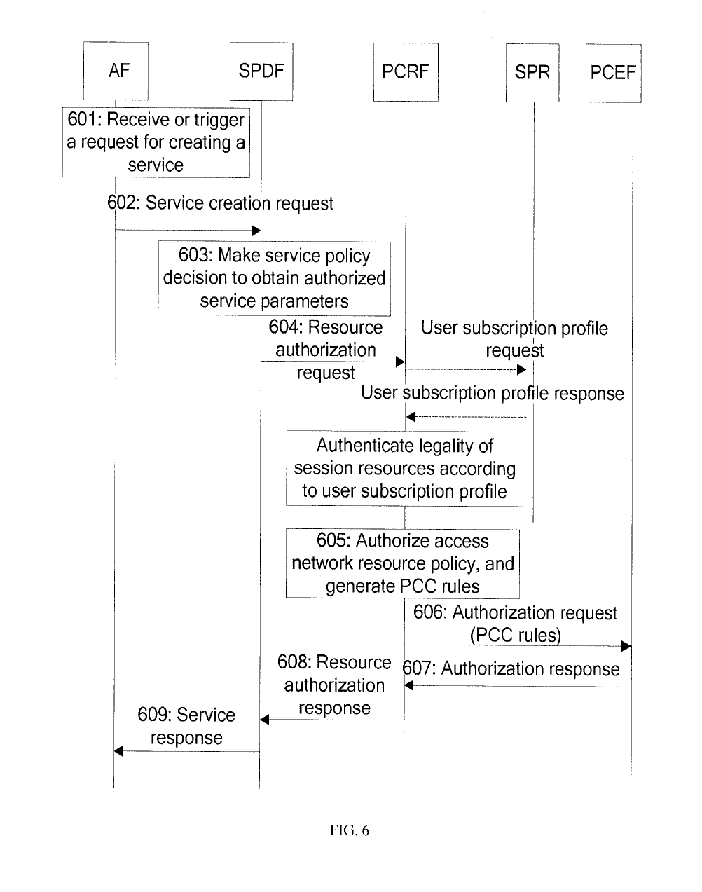

The first is the resource request process. As shown in FIG. 6, in the case of requesting resources, policy control includes the following steps:

Step 601: The AF receives or triggers a request for creating a service.

Step 602: The AF sends a service establishment request to the SPDF. The service establishment request carries service information which includes QoS information required for implementing the service. In order to correlate the application layer charging with the access network charging, the service information may further include an application layer charging ID.

Step 603: The SPDF checks the service request. After the check succeeds, the SPDF makes service policy decision according to the service property of the session and the policy pre-configuration parameters to obtain the authorized service parameters.

Step 604: The SPDF determines the corresponding local network transmission PDF according to the access network type, and sends a resource authorization request that carries the authorized service parameters to the local network transmission PDF. In this step, in order to correlate the application layer charging with the access network charging, the SPDF may further send an application layer charging ID to the local network transmission PDF.

In the following description, it is assumed that the access network is a mobile network and the local network transmission PDF is a PCRF.

Step 605: The PCRF generates PCC rules according to received authorized service parameters. More specifically, the PCRF performs access network resource policy authorization according to the received authorized service parameters and the access network policy, and then generates PCC rules according to authorized service parameters obtained after the access network resource authorization. Nevertheless, in a preferred embodiment of the present invention, the PCC rules may be generated according to features of the access network and/or features of the policy enforcement point.

Before performing the access network resource policy authorization and generating the transmission policy, step 605 may further include:

The PCRF authenticates the legality of the session resource according to the user subscription profile; perform step 605 if the authentication succeeds, or reject the service request if the authentication fails. In order to authenticate the legality of the session resource, if the PCRF lacks the user subscription profile, before step 605, the method further includes:

The PCRF requests an SPR for the user subscription profile.

Step 606: The PCRF sends an authorization request that carries PCC rules to the PCEF which serves as a policy enforcement point. The PCEF installs the PCC rules and performs policy control according to the PCC rules.

This embodiment may further include:

Step 607: The PCEF returns an authorization response to the PCRF in response to the authorization request sent by the PCRF. The authorization response may carry the access network charging ID and the charging point address.

Step 608: After receiving the authorization response, the PCRF returns a resource authorization response to the SPDF in response to the resource authorization request sent by the SPDF. The resource authorization response may carry the access network charging ID and the charging point address.

Step 609: The SPDF returns a service response to the AF. The service response may carry the access network charging ID and the charging point address. The AF correlates the application layer charging with the access network charging according to the ID and the address.

In a preferred embodiment of the present invention, the message exchange between the PCRF and the SPDF and PCEF may be performed by the PDF.

In the foregoing embodiment, the mobile network is taken as an example. When the local access network is a fixed connection network, the local network transmission PDF is an access network resource admission control function. Accordingly, the policy enforcement point is a bearer gateway. Other details are the same as the description in the foregoing embodiment.

In the foregoing resource request process, the corresponding local network transmission PDF is determined through the SPDF, and the determined local network transmission PDF generates local network transmission policy. Therefore, the local network transmission policy can be generated for different types of networks through a uniform network architecture, which is conducive to convergence of different networks.

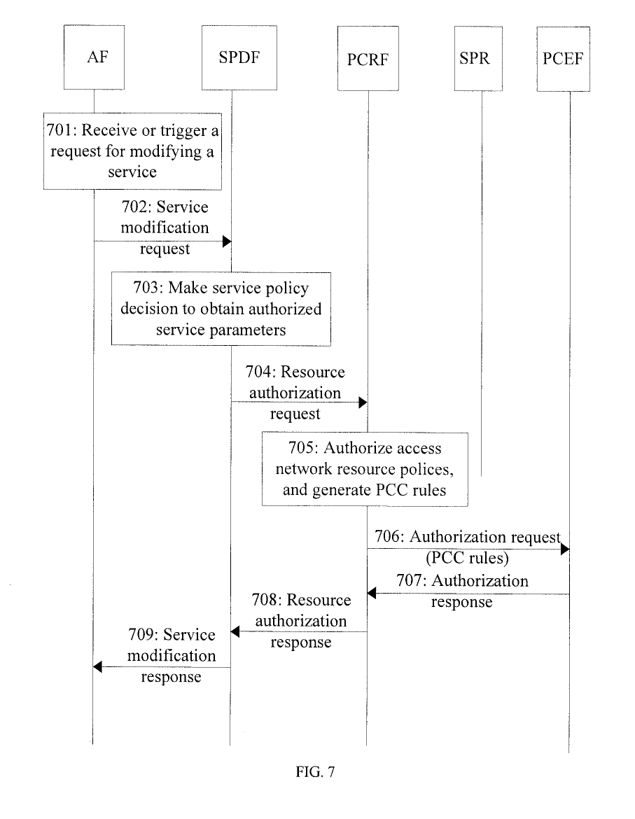

The second is the resource modification process: As shown in FIG. 7, in the case of modifying resources, policy control includes the following steps:

Step 701: The AF receives or triggers a request for modifying a service.

Step 702: The AF sends a service modification request to the SPDF. The service establishment request carries modified service information which includes modified service QoS information. In order to correlate the application layer charging with the access network charging, the service information may further include an application layer charging ID.

Step 703: The SPDF checks the service modification request again. After the check succeeds, the SPDF makes service policy decision again according to the service property of the session and the policy pre-configuration parameters to obtain new authorized service parameters.

Step 704: The SPDF determines the corresponding local network transmission PDF according to the access network type, and resends a resource authorization request that carries the authorized service parameters to the local network transmission PDF. In this step, in order to correlate the application layer charging with the access network charging, the SPDF may further send an application layer charging ID to the local network transmission PDF.

In the following description, it is assumed that the access network is a mobile network and the local network transmission PDF is a PCRF.

Step 705: The PCRF regenerates PCC rules according to received authorized service parameters. More specifically, the PCRF performs access network resource policy authorization according to the received authorized service parameters and the access network policy, and then generates PCC rules according to authorized service parameters obtained after the access network resource authorization. Nevertheless, in a preferred embodiment of the present invention, the PCC rules may be generated according to features of the access network and/or features of the policy enforcement point.

Step 706: The PCRF sends a modification authorization request that carries PCC rules to the PCEF which serves as a policy enforcement point. The PCEF installs the PCC rules and performs policy control according to the PCC rules.

This embodiment may further include the following steps:

Step 707: The PCEF returns a modification authorization response to the PCRF in response to the modification authorization request sent by the PCRF. The modification authorization response may carry the access network charging ID and the charging point address.

Step 708: After receiving the modification authorization response, the PCRF returns a resource modification response to the SPDF in response to the resource authorization request resent by the SPDF. The resource modification response may carry the access network charging ID and the charging point address.

Step 709: The SPDF returns a service modification response to the AF. The service modification response may carry the access network charging ID and the charging point address. The AF correlates the application layer charging with the access network charging according to the ID and the address.

In a preferred embodiment of the present invention, the message exchange between the PCRF and the SPDF and PCEF may be performed by the PDF.

In the foregoing embodiment, the mobile network is taken as an example. When the local access network is a fixed connection network, the local network transmission PDF is an access network resource admission control function. Accordingly, the policy enforcement point is a bearer gateway. Other details are the same as the description in the foregoing embodiment.

It should be noted that the resource modification process may be initiated not only by the AF, but also by the terminal, PCEF, PCRF, or SPR, and the subsequent operations are the same as the counterpart in the foregoing embodiment.

In the foregoing resource modification process, the corresponding local network transmission PDF is determined through the SPDF, and the determined local network transmission PDF regenerates local network transmission policy. Therefore, the local network transmission policy can be regenerated for different types of networks through a uniform network architecture, which is conducive to convergence of different networks.

In addition to the resource request process and the resource modification process described above, a resource release process is provided in an embodiment of the present invention. As shown in FIG. 8, the resource release process includes the following steps:

Step 801: The AF receives or triggers a request for releasing a service.

Step 802: The AF sends a service release request to the SPDF, requesting to release the currently allocated resource.

Step 803: The SPDF deletes service information, determines the corresponding local network transmission PDF according to the access network type, and sends a resource release request to the local network transmission PDF.

In the following description, it is assumed that the access network is a mobile network and the local network transmission PDF is a PCRF.

Step 804: The PCRF deletes the authorized PCC rules, and sends a resource release request to the PCEF.

Step 805: The PCEF releases the allocated access network resource, deletes or modifies the service flow, and returns a resource release response to the PCRF to confirm success of releasing the resource.

The resource release process may further include:

Step 806: The PCRF returns a resource release response to the SPDF, indicating success of releasing the resource.

Step 807: The SPDF returns a service release response to the AF to confirm success of releasing the resource.

In a preferred embodiment of the present invention, the message exchange between the PCRF and the SPDF and PCEF may be performed by the PDF.

In the foregoing embodiment, the mobile network is taken as an example. When the local access network is a fixed connection network, the local network transmission PDF is an access network resource admission control function. Accordingly, the policy enforcement point is a bearer gateway. Other details are the same as the description in the foregoing embodiment.

It should be noted that the resource release process may be initiated not only by the AF, but also by the terminal, PCEF, PCRF, or SPR, and the subsequent operations are the same as the counterpart in the foregoing embodiment.

In the resource release process described above, a uniform network architecture is used to generate the local network transmission policy. Therefore, it is necessary only to delete the local network transmission policy and release the resource on the basis of the uniform architecture, but not necessary for different type of network to perform the foregoing operations in its only way separately. The workload involved in the resource release process is reduced, and different types of networks can converge conveniently.

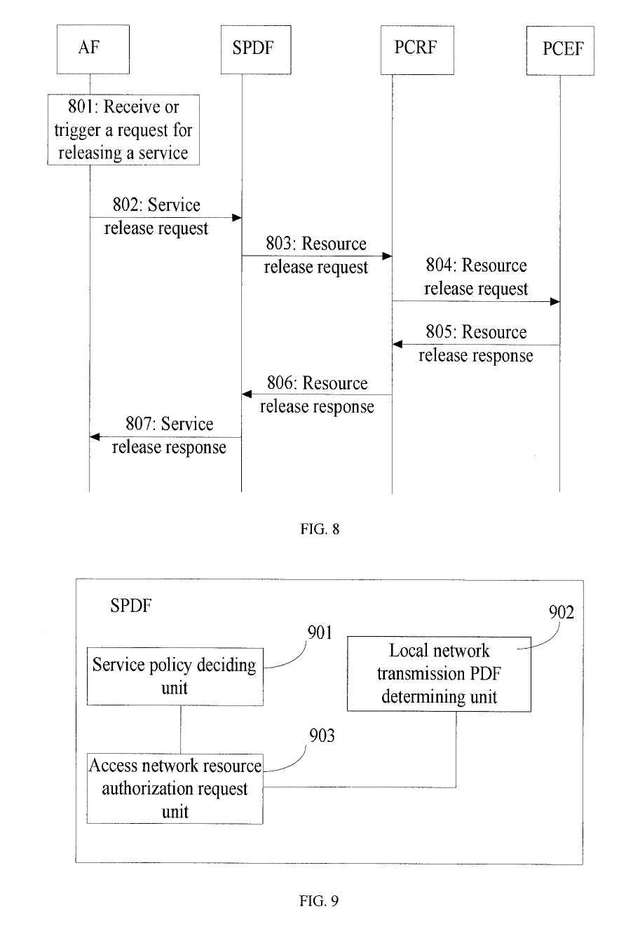

Corresponding to the method above, an SPDF for implementing policy control is provided in an embodiment of the present invention. As shown in FIG. 9, the SPDF includes:

a service policy deciding unit 901, configured to: make a service policy decision according to policy pre-configuration parameters and service property of a session to obtain authorized service parameters, where the service property of the session are carried in a service request sent by an AF;

a local network transmission PDF determining unit 902, configured to determine a corresponding local network transmission PDF according to a type of an access network; and

access network resource authorization request unit 903, configured to send an access network resource authorization request to the determined local network transmission PDF, where the request carries the authorized service parameters.

In order to correlate the application layer charging with the access layer charging, the SPDF further includes:

an application layer charging ID delivering unit, configured to deliver the application layer charging ID received from the AF to the local network transmission PDF; and

an application layer charging ID reporting unit, configured to report the access network charging ID obtained from the local network transmission PDF to the AF.

Through the SPDF provided in the foregoing embodiment, the corresponding local network transmission PDF is determined according to different type of access network, the corresponding request is sent to the determined PDF, and this PDF generates the local network transmission policy. Because the corresponding entity is determined according to different type of network, different types of networks can converge effectively with respect to policy control.

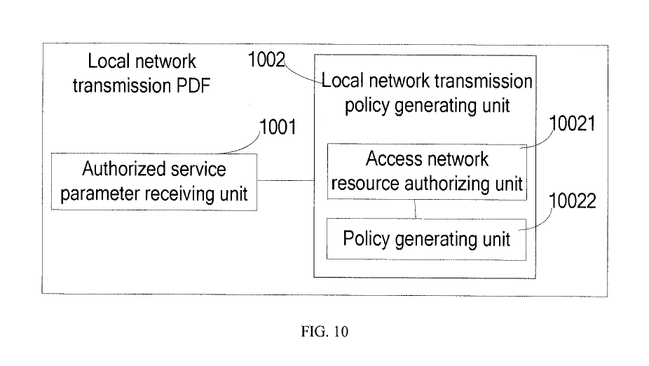

Corresponding to the method above, a local network transmission PDF for implementing policy control is provided in an embodiment of the present invention. As shown in FIG. 10, the local network transmission PDF includes:

an authorized service parameter receiving unit 1001, configured to receive authorized service parameters sent by an SPDF; and

a local network transmission policy generating unit 1002, configured to: generate a local network transmission policy according to the authorized service parameters, and deliver the policy to a corresponding policy enforcement point for enforcing.

In a preferred embodiment of the present invention, the local network transmission policy generating unit 1002 may include:

an access network resource authorizing unit 10021, configured to: perform access network resource policy authorization according to authorized service parameters to obtain authorized service parameters that are obtained after the access network resource authorization; and

a policy generating unit 10022, configured to: generate the local network transmission policy according to the obtained authorized service parameters, and deliver the policy to a corresponding policy enforcement point for enforcing. On occasion of generating the local network transmission policy, the policy generating unit 10022 may generate the policy according to features of the access network and features of the policy enforcement point.

The local network transmission PDF may further include:

a session resource legality judging unit, configured to judge legality of a session resource according to a user subscription profile.

The local network transmission PDF provided in the foregoing embodiment can generate local network transmission policy according to the authorized service parameters sent by the SPDF. Because the local network transmission PDF generates the local network transmission policy corresponding to different type of access network respectively, different types of networks can converge effectively.

It should be noted that the mobile network in the embodiments above may be, but without being limited to, a WiMAX access network, a 3GPP access network, a 3GPP2 access network, or a WLAN access network.

Persons of ordinary skilled in the art understand that all or part of the steps of the method in the embodiments of the present invention may be implemented by a program instructing relevant hardware. The program may be stored in a computer readable storage medium. When the program runs, at least the following steps are performed: The SPDF receives a service request from an AF, makes service policy decision according to the service property of the session and policy pre-configuration parameters to obtain authorized service parameters; and determines a corresponding local network transmission PDF according to the type of an access network; the SPDF sends an access network resource authorization request that carries the authorized service parameters to the determined local network transmission PDF, to enable the local network transmission PDF to generate a local network transmission policy according to the authorized service parameters and delivers the policy to a corresponding policy enforcement point for enforcing. The storage medium may be ROM/RAM, magnetic disk, or CD-ROM.

Although the invention is described through some exemplary embodiments, the invention is not limited to such embodiments. It is apparent that those skilled in the art can make modifications and variations to the invention without departing from the spirit and scope of the invention. The invention is intended to cover the modifications and variations provided that they fall in the scope of protection defined by the following claims or their equivalents.

What is claimed is:

1. A method for implementing policy control, comprising:
by a Service-based Policy Decision Function (SPDF), receiving a service request that carries a service property of a session from an Application Function (AF), making a service policy decision according to the service property of the session and policy pre-configuration parameters to obtain authorized service parameters; and determining a corresponding local network transmission Policy Decision Function (PDF) according to a type of an access network; and
sending, by the SPDF, an access network resource authorization request that carries the authorized service parameters to the determined local network transmission PDF, to enable the local network transmission PDF to generate a local network transmission policy according to the authorized service parameters and deliver the policy to a corresponding policy enforcement point for enforcing.

2. The method of claim 1, wherein:
the service request is either a service establishment request or a service modification request.

3. The method of claim 1, wherein before generating the local network transmission policy, the method further comprises:
authenticating, by the local network transmission PDF, legality of session resources according to a user subscription profile.

4. The method of claim 1, further comprising:
after receiving, by the SPDF, a service release request, deleting service information, and sending a resource release request to the corresponding local network transmission PDF according to the type of the access network; and
deleting, by the local network transmission PDF, the local network transmission policy,
releasing, by the policy enforcement point, currently allocated resources after receiving a resource release notification sent by the local network transmission PDF.

5. The method of claim 1, further comprising:
receiving, by the SPDF, an application layer charging identifier (ID) from the AF, and sending the ID to the local network transmission PDF; and
submitting, by the local network transmission PDF, an access network charging ID and a charging point address to the SPDF;
sending, by the SPDF, the access network charging ID and the charging point address to the AF.

6. The method according to claim 1, wherein:
if the local network is a mobile network, the local network transmission PDF is a Policy Control and Charging Rule Function (PCRF); and
the generating of the local network transmission policy and delivering of the policy to the corresponding policy enforcement point for enforcing comprises:
generating, by the PCRF, Policy Control and Charging (PCC) rules that comprise the local network transmission policy, and delivering the PCC rules to a Policy and Charging Enforcement Function (PCEF) for enforcing.

7. The method according to claim 1, wherein:
if the local network is a fixed connection network, the local network transmission PDF is an Access network-Resource and Admission Control Function (A-RACF); and
the generating of the local network transmission policy and delivering of the policy to the corresponding policy enforcement point for enforcing comprises:
generating, by the A-RACF, a transmission policy and submitting the transmission policy to a Resource Control Enforcement Function (RCEF) on a gateway for enforcing.

8. The method according to claim 1, wherein generating of the local network transmission policy by the local network transmission PDF according to the authorized service parameters comprises:
performing, by the local network transmission PDF, access network resource policy authorization according to the authorized service parameters to obtain authorized service parameters that are obtained after the access network resource policy authorization, and generating the local network transmission policy according to the obtained authorized service parameters.

9. The method according to claim 1, wherein:
the SPDF receives the service request from the AF through a uniform interface to an application layer.

10. A Service-based Policy Decision Function (SPDF), comprising:
a service policy deciding unit, configured to: make a service policy decision according to policy pre-configuration parameters and a service property of a session to obtain authorized service parameters, wherein the service property of the session are carried in a service request sent by an Application Function (AF);
a local network transmission Policy Decision Function (PDF) determining unit, configured to determine a corresponding local network transmission PDF according to a type of an access network; and
access network resource authorization request unit, configured to send an access network resource authorization request to the determined local network transmission PDF, wherein the request carries the authorized service parameters.

11. The entity of claim 10, further comprising:
an application layer charging identifier (ID) delivering unit, configured to deliver an application layer charging ID received from the AF to the local network transmission PDF; and
an application layer charging ID reporting unit, configured to report the access network charging ID obtained from the local network transmission PDF to the AF.

12. A local network transmission Policy Decision Function (PDF) for implementing policy control, comprising:
an authorized service parameter receiving unit, configured to receive authorized service parameters sent by a Service-based Policy Decision Function (SPDF); and
a local network transmission policy generating unit, configured to: generate a local network transmission policy according to the authorized service parameters, and deliver the policy to a corresponding policy enforcement point for enforcing.

13. The entity of claim 12, wherein the local network transmission policy generating unit comprises:
an access network resource authorizing unit, configured to: perform access network resource policy authorization according to the authorized service parameters to obtain authorized service parameters that are obtained after the access network resource authorization; and
a policy generating unit, configured to: generate the local network transmission policy according to the obtained authorized service parameters, and deliver the policy to a corresponding policy enforcement point for enforcing.

14. The entity of claim 12, further comprising:
a session resource legality judging unit, configured to judge legality of a session resource according to a user subscription profile.

15. A system for implementing policy control, comprising:
a Service-based Policy Decision Function (SPDF), configured to: make a service policy decision according to service policy pre-configuration parameters and a service property of a session to obtain authorized service parameters, wherein the service property of the session are carried in a service request sent by an Application Function (AF); determine a corresponding local network transmission Policy Decision Function (PDF) according to a type of an access network; and send an access network resource authorization request that carries the authorized service parameters to the determined local network transmission PDF; and
the local network transmission PDF, configured to: generate a local network transmission policy according to the authorized service parameters after receiving the access network resource authorization request from the SPDF, and deliver the policy to a corresponding policy enforcement point for enforcing.

16. The system of claim 15, wherein:
if the local network is a mobile network, the local network transmission PDF is a Policy Control and Charging Rule Function (PCRF), and the policy enforcement point is a Policy and Charging Enforcement Function (PCEF); and
if the local network is a fixed connection network, the local network transmission PDF is an Access network-Resource and Admission Control Function (A-RACF), and the policy enforcement point is a Resource Control Enforcement Function (RCEF) located on a gateway.
